(19) United States
(12) Patent Application Publication
(10) Pub. No.: US 2024/0126098 A1
(43) Pub. Date: Apr. 18, 2024

(54) EYEWEAR PRODUCT AND METHOD OF PRODUCING SAME

(71) Applicant: Paper Shades Limited

(72) Inventor: James Louis CHU, Kennedy Town (HK)

(21) Appl. No.: 17/768,448

(22) PCT Filed: Oct. 21, 2020
(86) PCT No.: PCT/CN2020/122369

§ 371 Date: Apr. 12, 2022

(51) Int. Cl. G02C 5/22; G02C 5/14

(52) U.S. Cl. CPC G02C 5/22; G02C 5/14

(57) ABSTRACT

A method of producing an eyewear product having a frame configured for holding a pair of optical lenses, first and second temples configured for hinged attachment proximate to first and second edges of the frame via a first and a second hinge element respectively, each of the first and second temples having holes extending therein between first sides of the first and second temples and second sides of the first and second temples, the frame having holes extending therein at the first and second edges of the frame between a first side of the frame and a second side of the frame, and each of the first and second hinge elements having a first and second hole extending therein between first sides of each of the first and second hinge elements and second sides of each of the first and second hinge elements.

### TECHNICAL FIELD

The present invention relates to methods pf producing eyewear products such as sunglasses, reading glasses, protective glasses and the like.

### BACKGROUND OF THE INVENTION

Eyewear products such as sunglasses are assembled from various parts including a frame for holding a pair of optical lenses, and, a pair of temples connected to left and right edges of the frame by hinges. The temples extend away from the frame so that they may engage with the user's ears when the eyewear product is being worn. When such eyewear products are manufactured according to conventional methods, the various parts of the eyewear product are manually screwed together with the screws being driven in to the parts in different relative orientations and along different axes of movement in multiple steps. This is at least partially due to the relatively rigid structure and restricted scope of movement inherent in the hinge elements, frame and temples of conventional sunglasses. Consequently, the manufacturing process for such conventional type eyewear products tends to be a relatively inefficient and tedious process that is considered to be in need of improvement.

### SUMMARY OF THE INVENTION

The present invention seeks to alleviate at least one of the above-described problems.

The present invention may involve several broad forms. Embodiments of the present invention may include one or any combination of the different broad forms herein described.

In one broad form, the present invention provides a method of producing an eyewear product having a frame configured for holding a pair of optical lenses, first and second temples configured for hinged attachment proximate to first and second edges of the frame via a first and a second hinge element respectively, each of the first and second temples having holes extending therein between first sides of the first and second temples and second sides of the first and second temples, the frame having holes extending therein at the first and second edges of the frame between a first side of the frame and a second side of the frame, and each of the first and second hinge elements having a first and second hole extending therein between first sides of each of the first and second hinge elements and second sides of each of the first and second hinge elements, and wherein the method including steps of:
(i) arranging the frame and first and second temples on an assembly surface such that the holes extending in to each of the frame and the first and second temples are aligned and extend away the assembly surface; and
(ii) thereafter, arranging the first hinge element over the first temple and the first edge of the frame such that the first hole of the first hinge element is aligned with the hole of the first temple, and the second hole of the first hinge element is aligned with the hole at the first edge of the frame;
arranging the second hinge element over the second temple and the second edge of the frame such that the first hole of the second hinge element is aligned with the hole of the second temple, and the second hole of the second hinge element is aligned with the hole at the second edge of the frame; and
(iii) thereafter, arranging a first rivet or screw substantially in alignment with the first hole of the first hinge element and the hole of the first temple;
arranging a second rivet or screw substantially in alignment with the second hole of the first hinge element and the hole at the first edge of the frame;
arranging a third rivet or screw substantially in alignment with the first hole of the second hinge element and the hole of the second temple;
arranging a fourth rivet or screw substantially in alignment with the second hole of the second hinge element and the hole at the second edge of the frame;
(iv) thereafter, forcing each of the first, second, third and fourth rivets or screws through the respective holes with which the rivets or screws are substantially aligned so that the rivets or screws secure the first and second temples to the frame via the first and second hinge elements; and
whereby the first and second hinge element may thereafter be configured to be folded or bended such that the first and second temples are arranged to extend substantially transversely to a planar surface of the frame.

Preferably, the step of forcing each of the first, second, third and fourth rivets through the respective holes with which the rivets are substantially aligned so as to secure the first and second temples to the frame via the first and second hinge elements may be performed simultaneously.

Preferably, when assembled, at least one of the frame and the first and second temples may be configured for rotatable movement about the rivets connecting them to the first and second hinge elements so as to allow adjustment of the first and second temples relative to the frame.

Preferably, when the first and second temples are arranged to extend substantially transversely to the planar surface of the frame, ends of the first and second temples may be configured to abut against the planar surface of the frame.

Preferably, at least one of the frame, the first and second temples and the first and second hinges may include substantially flat configurations.

Preferably, ends of the rivets may be configured to undergo shape deformation when forced through the respective holes with which the rivets are substantially aligned so as to secure the first and second temples to the frame via the first and second hinge elements.

Preferably, the first and second hinge elements may be formed from at least one of a plastic material, a polymeric material and a metal material.

Preferably, at least one of the frame and the first and second temples are formed from cardboard.

Preferably, at least one of the first and second hinge elements includes a substantially flat sheet.

In another broad form, the present invention provides an eyewear product produced in accordance with any one of the steps of the first broad form of the present invention.

In another broad form, the present invention provides a hinge element configured for use with an eyewear product in accordance with any one of the steps of the first broad form of the present invention.

### BRIEF DESCRIPTION OF THE DRAWINGS

The present invention will become more fully understood from the following detailed description of a preferred but non-limiting embodiments thereof, described in connection with the accompanying drawings, wherein:

FIG. 1 shows a perspective view of the parts of an eyewear product laid flat on an assembly surface in readiness for rivets to be punched simultaneously through coaxially aligned holes in the various parts in a single step so as to effect securement of the various parts and assembly of the eyewear product in accordance with an embodiment of the present invention;

FIG. 2 shows a top view of the eyewear product in one configuration whereby the various parts are secured together after rivets have been punched through coaxially aligned holes in respective parts in accordance with an embodiment of the present invention;

FIG. 3 shows a perspective view of the eyewear product in another configuration whereby the various parts are secured together after rivets have been punched through coaxially aligned holes in respective parts in accordance with an embodiment of the present invention;

FIG. 4 shows a perspective view of another hinge element which may be used in alternate embodiments of the present invention; and

FIG. 5 shows a magnified-view of a hinge-element coupling a temple to a frame of an exemplary conventional type pair of sunglasses.

### DETAILED DESCRIPTION OF THE PREFERRED EMBODIMENTS

Preferred embodiments of the present invention will now be described herein with reference to the accompanying drawings.

In one embodiment of the present invention a method is provided for producing an eyewear product (1), such as for example a pair of sunglasses, reading glasses, safety glasses and the like. The eyewear product includes a frame (2) configured for holding a pair of optical lenses (3a,3b). In some embodiments, the optical lenses (3a,3b) may simply comprise transparent glass or plastic, or, the frame may be entirely devoid of lenses in some cases where the eyewear product is intended for use as a fashion accessory rather than for functional purposes to enhance the user's vision.

In this embodiment, the frame (2) and temples (4a,4b) are formed from rigid cardboard material although in other embodiments, they may be formed from any other suitably rigid material such as for instance plastic or metal.

The eyewear product (1) further includes first and second temples (4a,4b) each having first ends configured for hinged attachment proximate to first and second edges (2a,2b) of the frame (2) via a first and second hinge elements (5a,5b) respectively, and, each of the first and second temples (4a,4b) extend away from the first and second hinge elements (5a,5b) towards distal second ends. The first and second temples (4a,4b) are suitably shaped and dimensioned so that they may engage with a user's ears when the eyewear product (1) is being worn. The first and second hinge elements (5a,5b) in this embodiment are comprised by thin metal sheets that are able to be folded or bended. In other embodiments, the hinge elements (5a,5b) may for instance be formed from thin flat sheets of plastic, rubber or a polymeric material.

Each of the first and second temples (4a,4b) have holes (4a′,4b′) extending therein and therethrough between first sides of the first and second and second sides of the first and second temples (4a,4b). The holes (4a′,4b′) in the first and second temples (4a,4b) are disposed adjacent the first ends of each of the first and second temples (4a,4b). The frame (2) also includes holes (2a′,2b′) extending therein and therethrough at the first and second edges (2a,2b) of the frame (2) between a first side of the frame (2) and a second side of the frame (2).

Yet further, each of the first and second hinge elements (5a,5b) include a first hole (5a′,5a″) and a second hole (5b′,5b″) which extend therein and therethrough between first sides of each of the first and second hinge elements (5a,5b) and second sides of each of the first and second hinge elements (5a,5b). The first holes (5a′,5a″) and second holes (5b′,5b″) disposed in each of the first and second hinge elements (5a,5b) may be discrete separate holes, or, may be at least partially connected and may comprise portions of a larger hole in the first and second hinge elements. Although in these embodiments, the holes in the frame (2) and first and second temples (4a,4b) extend the whole way through each of these parts, it is conceivable that in alternate embodiments, the holes may partially extend through these parts. Furthermore, in this embodiment, the holes disposed in each of the parts of the eyewear product (1) have circular-shaped cross sections and are of substantially uniform diameter although this need not necessarily be required in all embodiments.

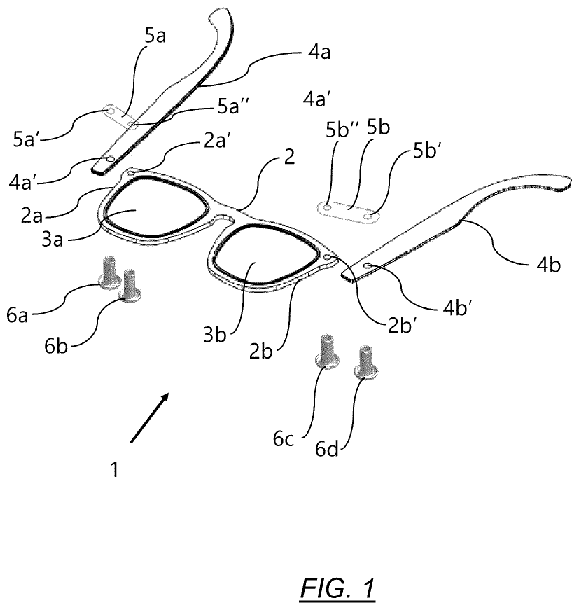

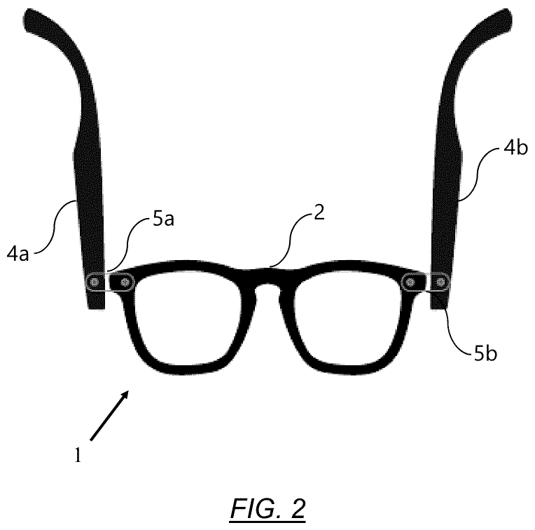

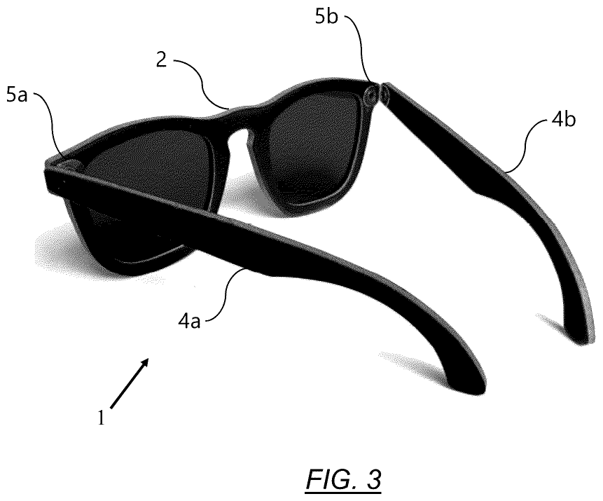

Referring particularly now to FIGS. 1 and 2, the eyewear product (1) may be assembled by first laying the frame (2) and first and second temples (4a,4b) side-by-side on a flat assembly bed. The frame (2) and first and second temples (4a,4b) include substantially flat shape configurations and are configured to lie flush upon the flat assembly bed. When the frame (2) and first and second temples (4a,4b) are arranged in this manner, elongate axes of each of the holes disposed in each of these parts extend upwardly from the flat surface of the assembly bed in substantially parallel orientation. It would be appreciated that the elongate axes of the aligned holes need not necessarily be strictly parallel although this may be advantageous for the step of punching the rivets through the aligned holes in a single step in a single direction and with minimal complexity. The first hinge element (5a) is laid flat over the first temple (4a) and the first edge (2a) of the frame (2) such that the first hole (5a′) of the first hinge element (5a) is aligned with an elongate axis of the hole (4a′) of the first temple (4a), and, the second hole (5a″) of the first hinge element (5a) is aligned with an elongate axis of the hole (2a′) at the first edge (2a) of the frame (2). The second hinge element (5b) is also laid flat over the second temple (4b) and the second edge (2b) of the frame (2) such that the first hole (5b′) of the second hinge element (5b) is aligned with an elongate axis of a hole (4b′) of the second temple (4b), and, the second hole (5b″) of the second hinge element (5b) is aligned with the hole (2b′) at the second edge (2b) of the frame (2). A plurality of rivets (4 rivets in this particular embodiment) are configured for arrangement so as to be ready for punching upwardly from the flat surface of the assembly bed through the aligned holes in the laid-out parts. In particular, a first rivet (6a) is arranged in substantially coaxial alignment with the first hole (5a′) of the first hinge element (5a) and the hole (4a′) of the first temple (4a). A second rivet (6b) is arranged in substantially coaxial alignment with an elongate axis of the second hole (5a″) of the first hinge (5a) element and the hole (2a′) at the first edge (2a) of the frame (2). A third rivet (6c) is arranged in substantially coaxial alignment with an elongate axis of the first hole (5b′) of the second hinge element (5b) and the hole (4b′) of the second temple (4b). A fourth rivet (6d) is arranged in substantially coaxial alignment with an elongate axis of the second hole (5b″) of the second hinge element (5b) and the hole (2b′) at the second edge (2b) of the frame (2). Thereafter, all four rivets (6a,6b,6c,6d) are preferably punched through the respective coaxially-aligned holes in the respective parts simultaneously, in a single direction and in a single processing step (although in certain embodiments the rivets need not necessarily be punched simultaneously but may for instance be punched sequentially or punched in pairs). The flat assembly bed may for instance include recesses disposed in the assembly bed and the rivets (6a,6b,6c,6d) may be configured to be punched upwardly from the recesses in the assembly bed surface and through the coaxially aligned holes of the various respective parts. There may also be provided a secondary surface arranged above the flat bed assembly surface against which ends of the rivets (6a,6b,6c,6d) that are punched through the coaxially-aligned holes may abut against so as to cause suitable deformation to the ends of the rivets (6a,6b,6c,6d) and which assists the rivets (6a,6b,6c,6d) in securely fastening the respective eyewear product parts together. Alternately, the rivets (6a,6b,6c,6d) may be configured for being simultaneously punched through the coaxially-aligned holes of the respective eyewear product parts that have been laid-out in flat form on the assembly bed in a direction downwardly towards the flat assembly bed. In certain embodiments, the ends of the rivets (6a,6b,6c,6d) may not necessarily need to deform and may simply hold the respective eyewear product parts together by frictional engagement alone. After the rivets (6a,6b,6c,6d) have been simultaneously punched through the respective coaxially-aligned holes, if necessary, the first and second temples (4a,4b) may be suitably rotated about the rivets securing the first and second temples (4a,4b) to the first and second hinge elements (5a,5b) respectively, the first and second hinge elements (5a,5b) may be suitably rotated about rivets securing them to the first and second edges (2a,2b) of the frame (2) respectively, and, the first and second hinge elements (5a,5b) may be suitably bent or folded such that the first and second temples (4a,4b) are configured for arrangement so as to extend from the first and second edges (2a,2b) of the frame (2) substantially transversely to a planar surface of the frame (2). Further, when the first and second temples (4a,4b) are arranged to extend substantially transversely to the planar surface of the frame (2), ends of the first and second temples (4a,4b) may be configured to abut against the planar surface of the frame (2) such as shown in FIG. 3. Alternately, once the rivets have been punched through, the hinges may be folded first and then the temples rotated about the axis of the rivets they're connected to so as to suitably arrange the eyewear product into a desired shape and configuration.

Embodiments of the present invention may provide a more efficient method of producing eyewear products by virtue of the eyewear product parts being assembled in flat form with all holes being arranged in parallel alignment so that all rivets (6a,6b,6c,6d) may be punched through the aligned holes of the respective parts in a single step, and in a single direction and in a single processing step without requiring re-orientation of the eyewear product parts and/or re-orientation of the assembly equipment in multiple processing steps or stages in order to effect manual securement of the eyewear product parts together by screws. Moreover, it will be appreciated that, because the hinge elements in these embodiments may be rotatable about the rivets connecting them to the first and second edges of the frame, and because the first and second temples are rotatable about the first rivets connecting them to the first and second hinge elements, and because the hinge elements may be suitably folded or bended, this provides for greater flexibility in the manufacturing process whereby the frame and first and second temples may be firstly secured together by arranging these parts on a flat-bed in side-by-side fashion, and punching rivets through the laid-flat parts in a single step in a single direction. In contrast with conventional type eyewear products, as the hinge elements may only allow for restricted movement of the temples in a rotating manner about the frame, it is not physically possible to first lay the temples, hinge elements and frame out in a laid-flat configuration to punch rivets through them in a single step in a single direction initially. Moreover, by virtue of the embodiments of the present invention allowing for the rivets to be punched through the various parts in a single step in a single direction, this lends itself to improved manufacturing efficiency at scale compared to conventional methods.

In certain alternate embodiments, instead of punching the rivets through the respective coaxially aligned holes, screws may be used instead which are simultaneously screwed in to the substantially coaxially aligned holes to effect securement of the respective parts. However, it is envisaged that the step of simultaneously screwing the screws in to the respective coaxially aligned holes may increase production time and costs as opposed to simply punching rivets through the respective coaxially aligned holes in order to effect securement. Yet further, in certain alternate embodiments, if the parts of the eyewear product are not entirely flat and are for instance curved, a jig may be used to seat the curved parts as the rivets are punched through aligned holes of the parts to effect securement.

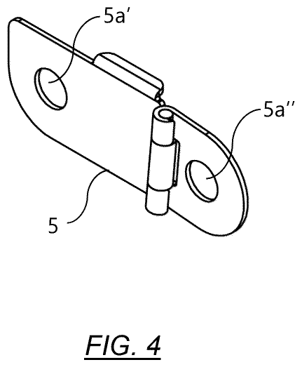

Referring to FIG. 4, an alternate hinge element which may be used in alternate embodiments of the present invention is shown which may typically be formed from a metal material. This alternate hinge element embodiment comprises first and second hinge elements that may be pivotable relative each other about a pivot axis. Either hinge type described herein (or yet other variations of the hinge element) suitable to the aesthetic requirements or manufacturing cost requirements may be utilised in these particular embodiments as long as the hinge element meets the functional requirement of being able to be arranged in flat-form upon the respective parts of the eyewear product being assembled so as to allow for the rivets or screws to be driven in to securement holes in the respective parts in a single processing step and in a substantially single axis of orientation. Yet further, regardless of the embodiment of hinge element that is employed, the hinge element will be configured for bending or folding so that the temples may be configured for arrangement in to substantially transverse orientation to the planar surface of the frame. Yet further, the frame and/or temples are configured for rotational movement about the rivets or screws securing them to each other via the hinge elements in such a manner that the parts may be rotatably adjusted as necessary in order to assist in suitably maneuvering the temples in to transverse orientation to the frame (in addition to folding or bending the hinge element) after the step of driving the rivets or screws in to the aligned respective parts. The materials, shapes and dimensions of the rivets, temples and/or frame may be suitably configured such that the parts may have a suitable amount of flexibility in rotational movement about the rivets or screws whilst at the same time, the frictional forces inherent in the securement of the parts by the rivets or screws enables the parts to substantially hold the parts in the adjusted configuration (i.e. without being too loose so that the eyewear product loses its shape and configuration after being adjusted). Similarly, the hinge element may also configured so that it may enjoy a suitable amount of flexibility in being folded or bent whilst being able to substantially maintain the parts of the eyewear product in the adjusted configuration, although this is not necessarily essential. Furthermore, in certain embodiments, the flat-bed assembly surface may not be precisely flat and may include some curvature whereby the axes in which the rivets or screws are driven in to the aligned parts may vary slightly.

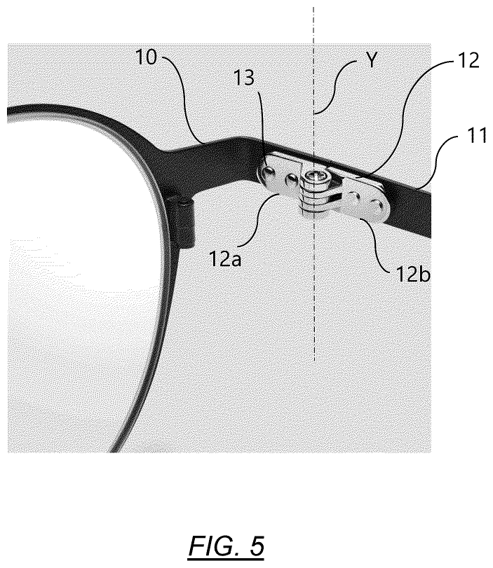

It will be appreciated from the above that embodiments of the present invention may provide at least one advantage over certain existing processes for assembling eyewear products. That is, embodiments of the present invention may allow for the eyewear product to be securely assembled in a relatively efficient manner in a single-step by driving rivets or screws through the parts of the product that have been laid out flat in a single axis of orientation. Moreover, after the rivets/screws have been driven in to aligned securement holes in the respective parts that have been arranged in flat-form, the temples may be quickly and easily rotated about the rivets/screws and the hinge element may be readily folded or bent about a pivot/bend axis of the hinge element in order to quickly and easily adjust the temples in to a relatively transverse orientation relative to a planar face of the frame in readiness for being worn by a user. Alternately, after the rivets/screws have been driven in to aligned securement holes in the respective parts that have been arranged in flat-form, the hinges may be folded first and then the temples rotated about the axis of the rivets. In contrast, and referring to FIG. 5 which depicts an exemplary conventional pair of glasses, it can be seen that the temples (11) and the frame (10) are secured together via a hinge element (12) by a screw that is driven through the co-axially aligned securement holes located in the frame (10), temple (11) and hinge element (12) along the axis (Y). It would be further appreciated that the hinge element (12) of the conventional pair of glasses in FIG. 5 is comprised by 2 separate hinge parts (12a,12b) that are each separately secured to the frame (10) and temple (11) respectively by rivets (13) before the screw can then be driven through the co-axially aligned securement holes in the frame (10), temple (11) and hinge (12) to complete the assembly. It will be evident that in order to assemble a convention eyewear product such as this, the parts cannot be laid-flat on a flat assembly bed and secured together in a single-step in a manner provided by embodiments of the present invention. Notably, rivets (13) in the conventional product cannot be rapidly and forcefully punched through the coaxially-aligned securement holes in the frame (10), temple (11), and hinge (12) in a single-direction or orientation as the inherent structures, rigidity and lack of flexibility in movement of the parts of the conventional eyewear product do not lend themselves to such a process. To attempt a similar assembly process with existing eyewear product parts and configurations would be both impractical and would result in damage to the parts of the conventional eyewear product. Instead, the conventional type eyewear product requires parts to be secured manually by hand in a relatively inefficient manner; secured in multiple steps by rivets (13) and screws rather than in a single-step; and, require the rivets (13) and screws to be driven in to the parts of the eyewear product during assembly in multiple orientations so that the process of making this product is more complex and time-consuming that compared to the present invention.

In certain embodiments, any one of the holes disposed in the frame, temples and hinge may include coverings which at least partially cover any one of said holes when the said holes are aligned and before the rivets are forced through said aligned holes.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A method of producing an eyewear product having a frame configured for holding a pair of optical lenses, first and second temples configured for hinged attachment proximate to first and second edges of the frame via a first and a second hinge element respectively, each of the first and second temples having holes extending therein between first sides of the first and second temples and second sides of the first and second temples, the frame having holes extending therein at the first and second edges of the frame between a first side of the frame and a second side of the frame, and each of the first and second hinge elements having a first and second hole extending therein between first sides of each of the first and second hinge elements and second sides of each of the first and second hinge elements, and wherein the method including steps of:
(i) arranging the frame and first and second temples on an assembly surface such that the holes extending in to each of the frame and the first and second temples are aligned and extend away the assembly surface; and
(ii) thereafter, arranging the first hinge element over the first temple and the first edge of the frame such that the first hole of the first hinge element is aligned with the hole of the first temple, and the second hole of the first hinge element is aligned with the hole at the first edge of the frame;
arranging the second hinge element over the second temple and the second edge of the frame such that the first hole of the second hinge element is aligned with the hole of the second temple, and the second hole of the second hinge element is aligned with the hole at the second edge of the frame; and
(iii) thereafter, arranging a first rivet or screw substantially in alignment with the first hole of the first hinge element and the hole of the first temple;
arranging a second rivet or screw substantially in alignment with the second hole of the first hinge element and the hole at the first edge of the frame;
arranging a third rivet or screw substantially in alignment with the first hole of the second hinge element and the hole of the second temple;
arranging a fourth rivet or screw substantially in alignment with the second hole of the second hinge element and the hole at the second edge of the frame;
(iv) thereafter, forcing each of the first, second, third and fourth rivets or screws through the respective holes with which the rivets or screws are substantially aligned so that the rivets or screws secure the first and second temples to the frame via the first and second hinge elements; and
whereby the first and second hinge element may thereafter be configured to be folded or bended such that the first and second temples are arranged to extend substantially transversely to a planar surface of the frame.

2. A method as claimed in claim 1 wherein, the step of forcing each of the first, second, third and fourth rivets through the respective holes with which the rivets are substantially aligned so as to secure the first and second temples to the frame via the first and second hinge elements is performed simultaneously.

3. The method of claim 1 wherein when assembled, at least one of the frame and the first and second temples are configured for rotatable movement about the rivets connecting them to the first and second hinge elements so as to allow adjustment of the first and second temples relative to the frame.

4. The method of claim 1 wherein when the first and second temples are arranged to extend substantially transversely to the planar surface of the frame, ends of the first and second temples are configured to abut against the planar surface of the frame.

5. The method of claim 1 wherein at least one of the frame, the first and second temples and the first and second hinges include substantially flat configurations.

6. The method of claim 1 wherein ends of the rivets are configured to undergo shape deformation when forced through the respective holes with which the rivets are substantially aligned so as to secure the first and second temples to the frame via the first and second hinge elements.

7. The method of claim 1 wherein the first and second hinge elements are formed from at least one of a plastic material, a polymeric material and a metal material.

8. The method of claim 1 wherein at least one of the frame and the first and second temples are formed from cardboard.

9. The method of claim 1 wherein at least one of the first and second hinge elements includes a substantially flat sheet.

10. The method of claim 1 wherein any one of the holes disposed in the frame, temples and hinge may include coverings which at least partially cover any one of said holes when the said holes are aligned and before the rivets are forced through said aligned holes.

11. An eyewear product produced in accordance with claim 1.

12. A hinge element for use in producing an eyewear product according to claim 1.
